(19) United States
(12) Patent Application Publication
(10) Pub. No.: US 2008/0054105 A1
(43) Pub. Date: Mar. 6, 2008

(54) Volume Displacement System for Irrigation Span

(76) Inventor: Thomas J. Korus, Lindsay, NE (US)

Correspondence Address: HOVEY WILLIAMS LLP, 10801 Mastin Blvd., Suite 1000, Overland Park, KS, 66210, US

(21) Appl. No.: 11/470,083

(22) Filed: Sep. 5, 2006

(51) Int. Cl. B05B 3/00

(52) U.S. Cl. 239/728; 239/722

(57) ABSTRACT

A pipe span of a mobile irrigation system has an elongated volume displacement body contained within the interior flow passage of the span so as to occupy space that would otherwise be available for liquid flow. The displacement body is of reduced transverse dimension relative to the inside diameter of the span so as to present a flow path around the outside of the body between the latter and the sidewall of the span. The length of the body selected for use depends upon the desired amount of volume to be displaced. Alternative embodiments of the displacement body include a tubular member with closed, opposite ends, a thin-walled tubular member provided with a rigid foam insert for strength, a thin-walled tubular member with internal stiffeners, and a rigid foam member devoid of a surrounding thin-walled tubular member.

### TECHNICAL FIELD

This invention relates to the field of mobile irrigation equipment and, more particularly, to a unique construction for the liquid-carrying pipe spans of such systems.

### BACKGROUND AND SUMMARY

Mobile irrigation systems sometimes stretch for great distances in the field. As a consequence, in order to structurally strengthen the long pipe spans of such systems it is a common practice to make the spans larger in diameter than necessary to handle water demands of the field. However, when such large spans become filled with water, the increased weight can cause a number of significant problems, including the formation of excessively deep wheel ruts and increased wear on shafts, motors, gears and other components.

The present invention provides a way of keeping the large diameter of the pipes for their structural benefits but reducing the effective internal volume of such spans so as to reduce the amount of water carried thereby, thus decreasing their overall weight in the field. In one preferred embodiment, an elongated displacement body such as a thin-walled tube of PVC material with closed ends is inserted into the span to occupy a portion of the space otherwise available for liquid flow. The displacement body is smaller in transverse dimension than the inside diameter of the span so as to create a flow path outside of the body between it and the interior surface of the span. Spacers can be utilized at a number of locations along the length of the span to keep the displacement body spaced away from outlets that might otherwise be blocked by the body. For strength purposes, the tubular body may have internal stiffening struts or the like or may be filled with a suitable rigid synthetic resinous foam that fills the interior of the body to resist collapse of the sidewalls thereof. In another embodiment the displacement body may comprise a member constructed of a suitable rigid synthetic resinous foam material without a surrounding thin-walled pipe or the like, provided that the member has a relatively low rate of water absorption and has sufficient structural integrity to withstand the internal pressures within the span and the abrasion from flowing water.

### BRIEF DESCRIPTION OF THE DRAWINGS

FIG. 1 is an isometric view of a typical irrigation system with which the present invention may be advantageously employed;

FIG. 2 is an enlarged, fragmentary longitudinal cross sectional view through one of the spans of such a system illustrating an internal volume displacement body within such span, such body taking the form of a tubular member having closed opposite ends;

FIG. 3 is a transverse cross sectional view of the embodiment in FIG. 2 taken substantially along line 3-3 of FIG. 2;

FIG. 4 is s cross sectional view similar to FIG. 3 illustrating another embodiment wherein a thin-walled pipe of PVC material or the like is filled with a rigid synthetic resinous foam member to add strength to the tubular member;

FIG. 5 is a transverse cross sectional view similar to FIG. 3 but showing a further embodiment wherein the thin-walled tubular member is reinforced by internal stiffeners; and

FIG. 6 is a transverse cross sectional view similar to FIG. 3 showing a further embodiment wherein the displacement body comprises a rigid synthetic resinous foam member without a surrounding thinned-walled tube or the like.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

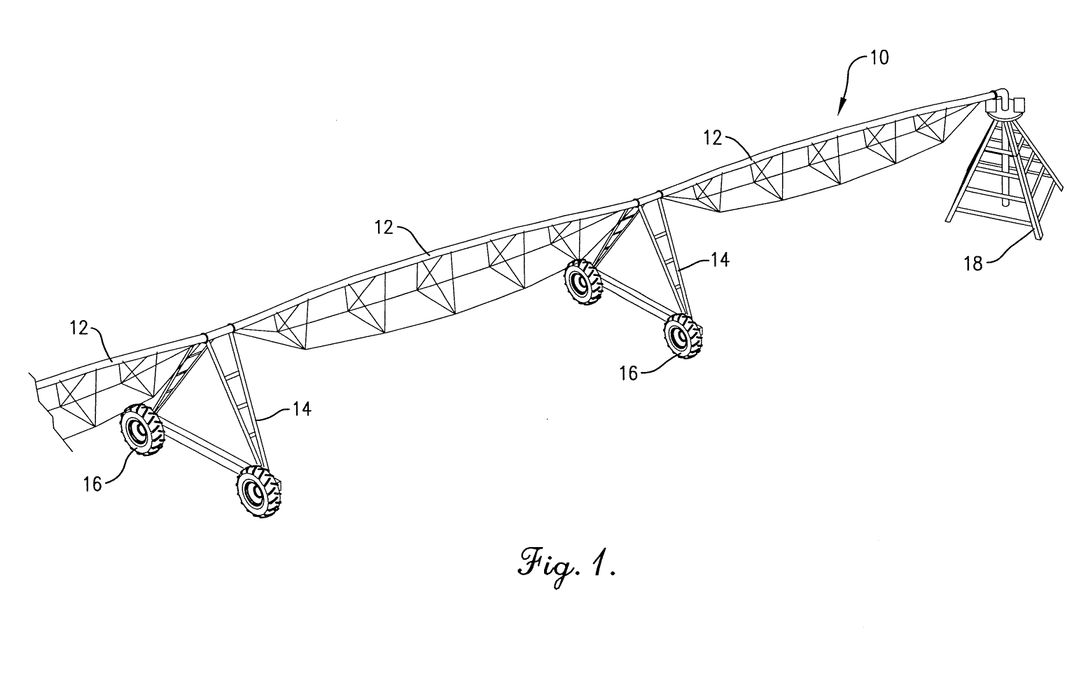

The irrigation system 10 selected for illustration in FIG. 1 includes a series of serially connected pipe spans 12 that are supported by movable towers 14 having ground wheels 16. Wheels 16 may be driven by suitable means such as electric motors (not shown) so as to transport spans 12 over ground to be irrigated. U.S. Pat. Nos. 4,693,425 and 6,231,450, assigned to the assignee of the present invention, disclose one suitable drive arrangement for the spans of an irrigation system and are hereby incorporated by reference into the present specification. FIG. 1 illustrates the spans 12 as part of a center pivot irrigation system having a fixed central tower 18, but the principles of the present invention may be applied to many other types of mobile irrigation systems as well including, for example, lateral move systems.

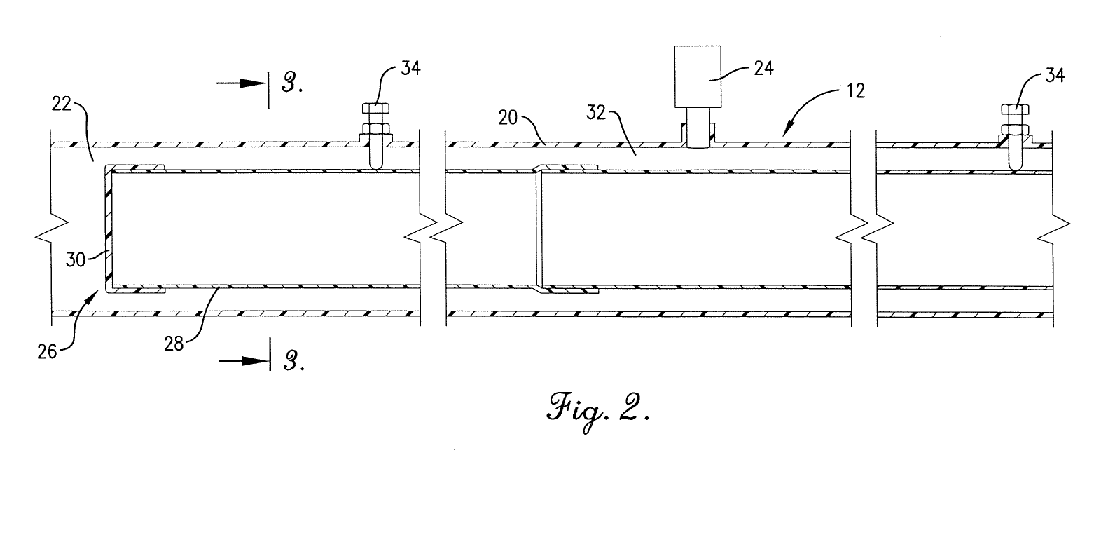

As illustrated in FIG. 2, each span 12 has a continuous annular sidewall 20 that defines an internal liquid flow passage 22. A series of outlets 24 are spaced along the length of span 12 and communicate with passage 22 for distributing liquid from passage 22 to the field. Outlets 24 may take a variety of different forms, including, for example, sprinklers or fittings to which hoses are connected to supply sprinkler heads at or near the ground surface. In the illustrated embodiment, the outlets 24 are located in the top portion of each span 12.

In the embodiment of FIGS. 2 and 3, a volume displacement body 26 in the form of a closed end tubular member 28 is housed within span 12 to occupy part of the passage 22 that would otherwise be available for liquid flow. In the illustrated embodiment, member 28 is hollow and is preferably of a suitable lightweight yet strong material such as Polyvinylchloride. End-to-end sections of member 28 are flanged and secured together using a suitable commercially available bonding agent. Member 28 is of a length that is selected in accordance with the desired volume of liquid to be displaced and is provided at each of its opposite ends with a cap 30 or the like to thereby close the end of the member and seal it against the entry of liquid.

Member 28 is smaller in transverse dimension than the inside diameter of span 12 so as to present a flow path 32 between the exterior of member 28 and the interior surface of sidewall 20 of span 12. In the illustrated embodiment, member 28 is cylindrical, although this is not a requirement. Thus, in the illustrated embodiment, it is contemplated that flow path 32 will surround member 28 and assume an annular configuration, although the particular cross sectional configuration of flow path 32 depends upon the transverse position of member 28 within span 12.

In the illustrated embodiment, because it is hollow, member 28 floats within span 12 when the latter is filled with liquid. In order to keep member 28 from blocking communication between flow path 32 and outlets 24, a series of spacers 34 may be provided along the length of span 12 to space member 28 away from outlets 24. While such spacers may be formed upon the exterior of member 28, in the illustrated embodiment they comprise set screws or the like carried by span 12 and projecting radially inwardly from sidewall 20 into contacting engagement with the exterior of member 28.

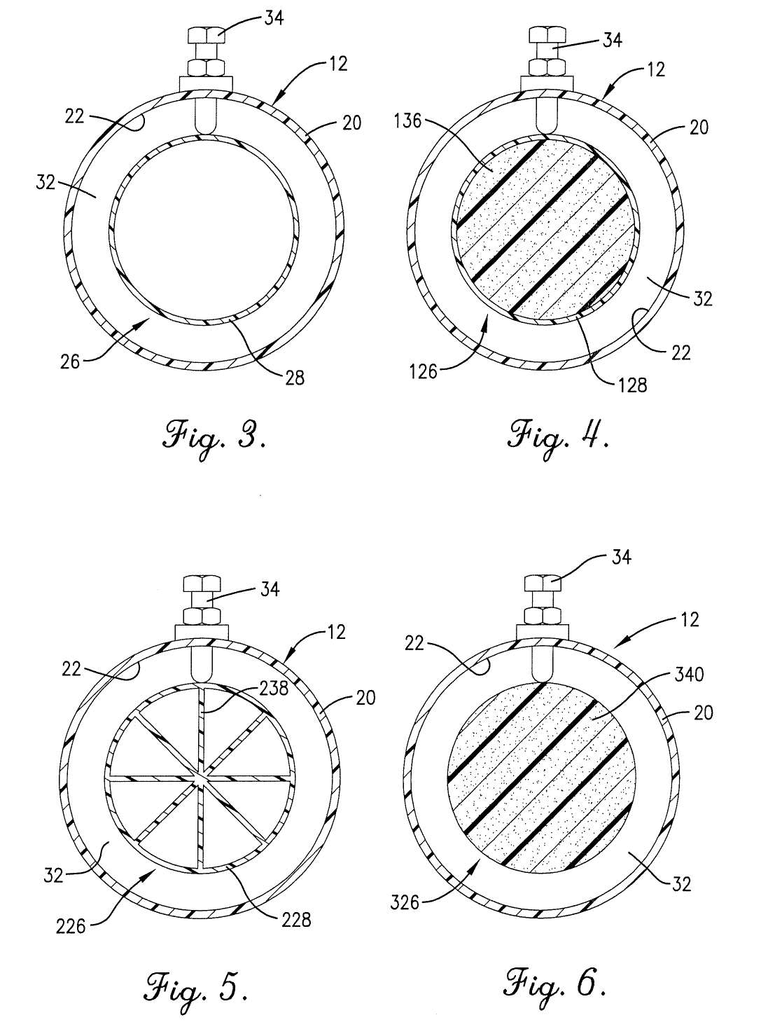

FIG. 4 illustrates a second embodiment wherein a volume displacement body 126 comprises a thin-walled tubular member 128 as in the embodiment of FIGS. 2-3 but surrounding a rigid synthetic resinous foam insert 136 to help strengthen the tubular member 128 and prevent collapse thereof under hydraulic pressure. Foam insert 136 may comprise a Styrofoam material of sufficient strength as to resist collapsing of member 128, or such other foam material capable of withstanding the hydraulic pressure existing within span 12.

FIG. 5 illustrates another embodiment wherein the volume displacement body 226 comprises a tubular member 228 like members 28 and 128 but provided with internal struts 238 or other such structure to resist collapse of tubular member 228.

In FIG. 6, a further embodiment is illustrated wherein volume displacement body 326 comprises a foam member 340 constructed of a rigid synthetic resinous foam material that is lightweight and has a very low water absorption rate. A dense Styrofoam maybe suitable depending upon the hydraulic pressures involved and the ability of such material to withstand the abrasive action of liquid flowing within the span 12.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In an irrigation system, the improvement comprising:
an irrigation span having an internal passage for receiving a flow of liquid therethrough and supported above the ground for movement relative thereto; and
an elongated volume displacement body received within said passage and extending axially of the span to occupy a portion of the space otherwise available for liquid flow,
said body being of reduced size relative to the inside diameter of the span to present a liquid flow path between the body and the span.

2. In an irrigation system as claimed in claim 1,
said body being hollow.

3. In an irrigation system as claimed in claim 2,
said hollow body having an outer wall and internal stiffening structure connected with said wall for resisting collapse thereof.

4. In an irrigation system as claimed in claim 2,
said body comprising a tubular member filled with a synthetic resinous foam material.

5. In an irrigation system as claimed in claim 1,
said body comprising a tube having a pair of closed, opposite ends.

6. In an irrigation system as claimed in claim 1,
said body being constructed from a synthetic resinous foam material.

7. In an irrigation system as claimed in claim 1,
said span having a plurality of outlets in a sidewall of the span,
further comprising a plurality of spacers between the body and said sidewall spacing the body away from said outlets.

8. In an irrigation system as claimed in claim 7,
said spacers being mounted on the span.

9. A method of reducing the effective volume of a mobile irrigation span comprising the step of inserting an elongated body into a flow passage of the span so that the body extends axially of the passage and occupies a portion of the space otherwise available for liquid flow, said body being of reduced size relative to the inside diameter of the span to present a liquid flow path between the body and the span.

10. A method as claimed in claim 9,
said span having a plurality of outlets in a sidewall of the span,
further comprising the step of spacing the body away from said outlets.
